(19) United States
(12) Patent Application Publication
(10) Pub. No.: US 2016/0283022 A1
(43) Pub. Date: Sep. 29, 2016

(54) Method and Device for Awakening an Element

(71) Applicant: Xiaomi Inc., Beijing (CN)

(72) Inventors: Kun YANG, Beijing (CN); Jun TAO, Beijing (CN); Zhongsheng JIANG, Beijing (CN)

(73) Assignee: Xiaomi Inc.

(21) Appl. No.: 14/988,245

(22) Filed: Jan. 5, 2016

(30) Foreign Application Priority Data
Mar. 26, 2015 (CN) 201510138363.6

(51) Int. Cl. G06F 3/041; G06K 9/00

(52) U.S. Cl. CPC G06F 3/0416; G06F 3/0412; G06K 9/00013

(57) ABSTRACT

The present disclosure provides a method and a device for awakening a fingerprint recognition element, which pertains to the field of mobile terminal. The method includes acquiring a touch signal by a touch component, determining whether the touch signal matches a preset condition, and if the touch signal matches the preset condition, awakening the fingerprint recognition element. Through the present disclosure, a fingerprint recognition element is awakened when a touch signal acquired by the touch component matches a preset condition, and it solves the problem that the fingerprint recognition element will seriously affect the runtime of the mobile terminal due to power consumption. Thereby, it achieves the effect that the fingerprint recognition element is awakened only in partial occasions and it is in a dormant state at most time, which will not seriously affect the runtime of the mobile terminal.

### CROSS-REFERENCE TO RELATED APPLICATIONS

The present application is based upon and claims priority to Chinese Patent Application No. 201510138363.6, and entitled “METHOD AND DEVICE FOR AWAKING ELEMENT”, filed Mar. 26, 2015, the entire contents of which are incorporated herein by reference.

### TECHNICAL FIELD

The present disclosure generally relates to the field of mobile terminal, and more particularly, to a method and a device for awakening an element.

### BACKGROUND

Fingerprint recognition technology is used more and more widely in mobile terminals such as a smart phone, a tablet PC, a laptop and the like.

Taking the smart phone as an example, a fingerprint identification element is provided in a touch key of the smart phone. When a user enables the smart phone, his/her fingerprint is recognized by the fingerprint recognition element and the smart phone will be normally enabled after the fingerprint is recognized successfully. When the user performs sensitive operations, his/her own fingerprint is recognized by the fingerprint recognition element and the sensitive operations will be performed after the fingerprint is recognized successfully.

### SUMMARY

The embodiments of the present disclosure provide a method and a device for awakening an element. The technical solution is as below.

According to a first aspect of the embodiments of the present disclosure, there is provided a method for awakening a fingerprint recognition element of a device, including receiving a touch signal by a touch component of the device, determining whether the touch signal matches a preset condition, and when the touch signal matches the preset condition, awakening the fingerprint recognition element.

According to a second aspect of the present disclosure, there is provided a device for awakening an element, including a processor,

a memory for storing instructions executable by the processor, a touch sensor, and a fingerprint recognition element. The processor is configured to receive a touch signal by the touch sensor, determine whether the touch signal matches a preset condition, and when the touch signal matches the preset condition, awaken the fingerprint recognition element.

According to a third aspect of the present disclosure, there is provided a non-transitory storage medium having stored therein instructions that, when executed by one or more processors of a terminal for awakening a fingerprint recognition element, causes the terminal to perform receiving a touch signal by a touch component, determining whether the touch signal matches a preset condition, and when the touch signal matches the preset condition, awakening the fingerprint recognition element.

The technical scheme according to embodiments of the present disclosure may have the following beneficial effects. A fingerprint recognition element is awakened when a touch signal acquired by the touch component matches a preset condition, and it solves the problem that the fingerprint recognition element will seriously affect the runtime of the mobile terminal due to power consumption. Thereby, it achieves the effect that the fingerprint recognition element is awakened only in partial occasions and it is in a dormant state at most time, which will not seriously affect the runtime of the mobile terminal

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a block diagram illustrating a mobile terminal according to an exemplary embodiment.

FIG. 2 is a flow chart showing a method for awakening an element according to an exemplary embodiment.

FIG. 3A is a flow chart showing a method for awakening an element according to another exemplary embodiment.

FIG. 3B is a schematic diagram showing a region involved in the method for awakening an element as shown in FIG. 3A.

FIG. 4 is a flow chart showing a method for awakening an element according to another exemplary embodiment.

FIG. 5A is a schematic diagram showing an internal structure of a mobile terminal according to an exemplary embodiment.

FIG. 5B is a schematic diagram showing an internal structure of a mobile terminal according to another exemplary embodiment.

FIG. 6 is a schematic diagram showing a region involved in the method for awakening an element according to another exemplary embodiment.

FIG. 7 is a flow chart showing a method for awakening an element according to another exemplary embodiment.

FIG. 8 is a schematic diagram showing an implementation involved in the method for awakening an element according to another exemplary embodiment.

FIG. 9 is a flow chart showing a method for awakening an element according to another exemplary embodiment.

FIG. 10 is a schematic diagram showing an implementation involved in the method for awakening an element according to another exemplary embodiment.

FIG. 11 is a block diagram illustrating a device for awakening an element according to an exemplary embodiment.

FIG. 12 is a block diagram illustrating a device for awakening an element according to another exemplary embodiment.

FIG. 13 is a block diagram illustrating a device for awakening an element according to another exemplary embodiment.

Through the above accompanying drawings, the specific embodiments of the disclosure have been shown, for which a more detailed description will be given as below. These drawings and textual description are not intended to limit the scope of the concept of the disclosure in any manner, but to explain the concept of the disclosure to those skilled in the art through particular embodiments.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

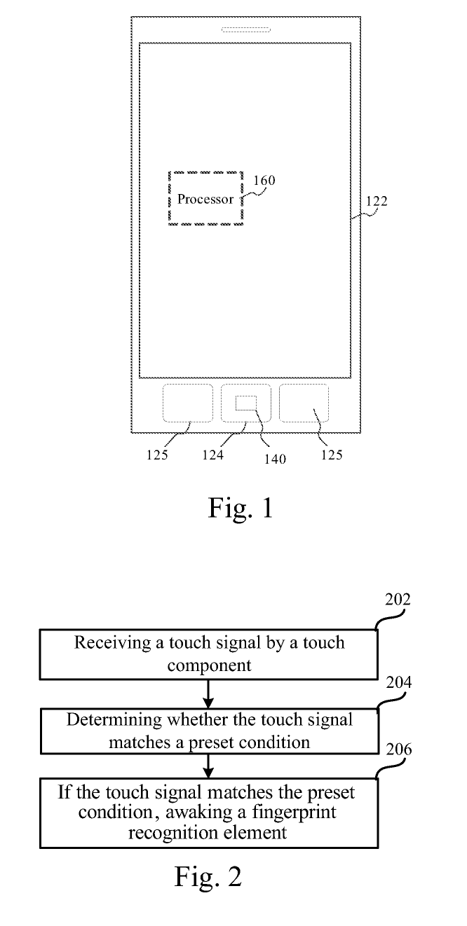

FIG. 1 is a block diagram illustrating a mobile terminal according to an exemplary embodiment. The mobile terminal 100 includes a touch screen 122, a touch key 124 provided at a peripheral side of the touch screen 122, a fingerprint recognition element 140 and a processor 160.

The touch screen 122 and the touch key 124 may be generally called as touch components. Operation of the touch screen 122 and the touch key 124 is controlled by a touch IC (integrated circuit), which is not shown in FIG. 1.

Generally, the touch key 124 is a key provided at the center below the touch screen 122. The front of the mobile terminal may include only one key, i.e. the touch key 124. Alternatively, the front of the mobile terminal includes three keys, i.e. the touch key 124 at the center, and the other touch keys 125 at two sides of the touch key 124. To simplify the description herein, FIG. 1 illustrates that the front of the mobile terminal includes three keys, as an example, but the present disclosure is not limited thereto.

The fingerprint recognition element 140 is provided in the touch key 124. The fingerprint recognition element 140 has the ability to identify the fingerprint of the user. In other embodiments, the fingerprint recognition element 140 may also be provided on the back of the mobile terminal

Both of the touch component and the fingerprint recognition element 140 are electrically connected with the processor 160.

FIG. 2 is a flow chart showing a method for awakening an element according to an exemplary embodiment. The present embodiment is illustrated by taking an example that applies the method for awakening an element to the mobile terminal as shown in FIG. 1. The method includes the following steps.

In step 202, a touch signal is received by a touch component. In step 204, it is determined whether the touch signal matches a preset condition. In step 206, if the touch signal matches the preset condition, a fingerprint recognition element is awakened. For example, the fingerprint recognition element is switched on when the touch signal matches the preset condition. The fingerprint recognition element may change from a dormant state to an active state. In other example, when the touch single matches the preset condition, electric power is applied to the fingerprint recognition element so that the fingerprint recognition element is ready to receive a touch signal by an external object.

Accordingly, in the method for awakening an element provided by the present embodiment, a fingerprint recognition element is awakened when a touch signal acquired by the touch component matches a preset condition, and it solves the problem that the fingerprint recognition element will seriously affect the runtime of the mobile terminal Thereby, it achieves the effect that the fingerprint recognition element is awakened only on certain occasions and it is in a dormant state at most times, which will not seriously affect the runtime of the mobile terminal

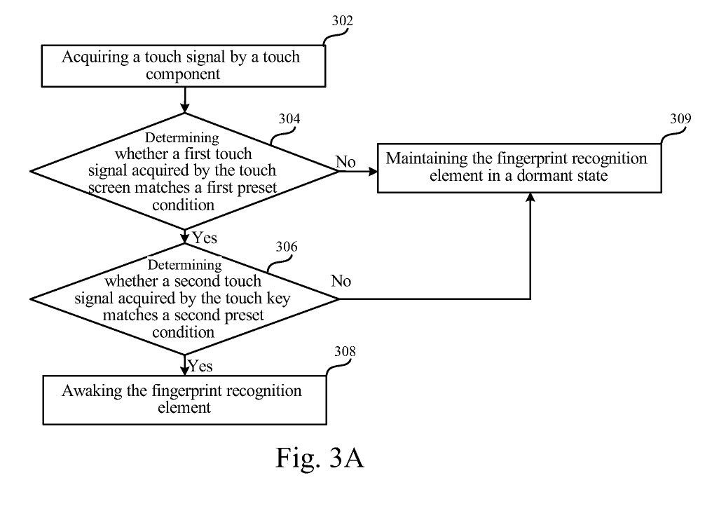

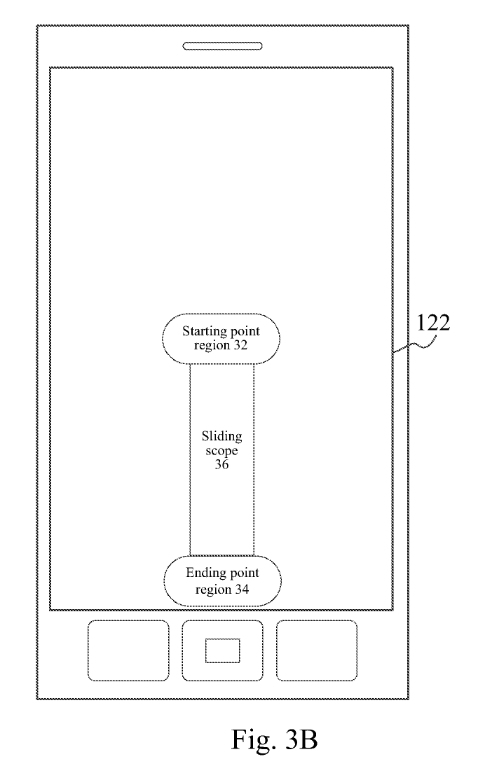

FIG. 3A is a flow chart showing a method for awakening an element according to another exemplary embodiment. The present embodiment is illustrated by taking an example that applies the method for awakening an element to the mobile terminal as shown in FIG. 1. The method includes the following steps.

In step 302, a first touch signal is acquired by a touch screen. When the user touches the touch screen, the mobile terminal collects the first touch signal by the touch screen. When the user touches the touch key, the mobile terminal collects the second touch signal by the touch key.

Combining with shown in FIG. 3B, the finger of the user slides downward from the center of the touch screen 122 to the touch key 124 and stays thereon. The mobile terminal collects the first touch signal by the touch screen 122, and then collects the second touch signal by the touch key 124.

In step 304, it is determined whether a first touch signal acquired by the touch screen matches a first preset condition.

The first preset condition includes, but not limited to, a single touch object sliding from a starting point region to an ending point region within the sliding scope.

For example, the starting point region may be an elliptical region 32 located at the center of the touch screen 122 as shown in FIG. 3B, the ending point region may be an elliptical region 34 located at the bottom of the touch screen 122 as shown in FIG. 3B, and the sliding scope is a rectangular region 36 located between the ellipse region 32 and the ellipse region 34.

If the first touch signal matches the first preset condition, it proceeds to step 306, and if the first touch signal does not match the first preset condition, it proceeds to step 309.

In step 306, if the first touch signal matches the first preset condition, it is determined whether a second touch signal acquired by the touch key matches a second preset condition.

The second preset condition includes, but not limited to, a signal amount generated when the touch object continuously touches on the touch key being larger than a preset threshold. The signal amount is related to a contact area and/or a time period of the touch object on the touch key. For example, the signal amount may be proportional to a size of the contact area. In other example, the signal amount may be proportional to the time period of the touch object on the touch key.

The second preset condition may determine whether the finger of the user stays on the touch key.

If the second touch signal matches the second preset condition, it proceeds to step 308, and if the second touch signal does not match the second preset condition, it proceeds to step 309.

In step 308, if the second touch signal matches the second preset condition, the fingerprint recognition element is awakened. The fingerprint recognition element is in a dormant state when the mobile terminal is in a standby state or sleep state. The fingerprint recognition element is awakened when the touch signals of the user match the preset conditions. The awakened fingerprint recognition element performs the fingerprint recognition function. When the mobile terminal returns to a standby state or sleep state, the fingerprint recognition element also returns to a dormant state. While the fingerprint recognition element is in a dormant state, it consumes no power or much less power than when it is awakened.

In step 309, the fingerprint recognition element is maintained in a dormant state.

Accordingly, in the method for awakening an element provided by the present embodiment, a first touch signal is collected by the touch screen firstly, then a second touch signal is collected by the touch key, and the fingerprint recognition element is awakened when both of the first touch signal and the second touch signal match the preset condition; and it solves the problem that the fingerprint recognition element will seriously affect the runtime of the mobile terminal Thereby, it achieves the effect that the fingerprint recognition element is awakened only in partial occasions and it is in a dormant state at most time, which will not seriously affect the runtime of the mobile terminal

The method for awakening an element provided by the present embodiment skillfully designs a second preset condition, such that, when the finger of the user stays on the touch key, i.e. the finger of the user is in a position needed when the fingerprint recognition element works, the fingerprint recognition element is awakened to perform fingerprint recognition. It avoids that the movement of the finger of the user affects the fingerprint recognition, thus improving accuracy of the fingerprint recognition.

In an embodiment, the touch screen is in a screen-extinguished detecting state, i.e. an operation state with low power consumption, when it collects the first touch signal.

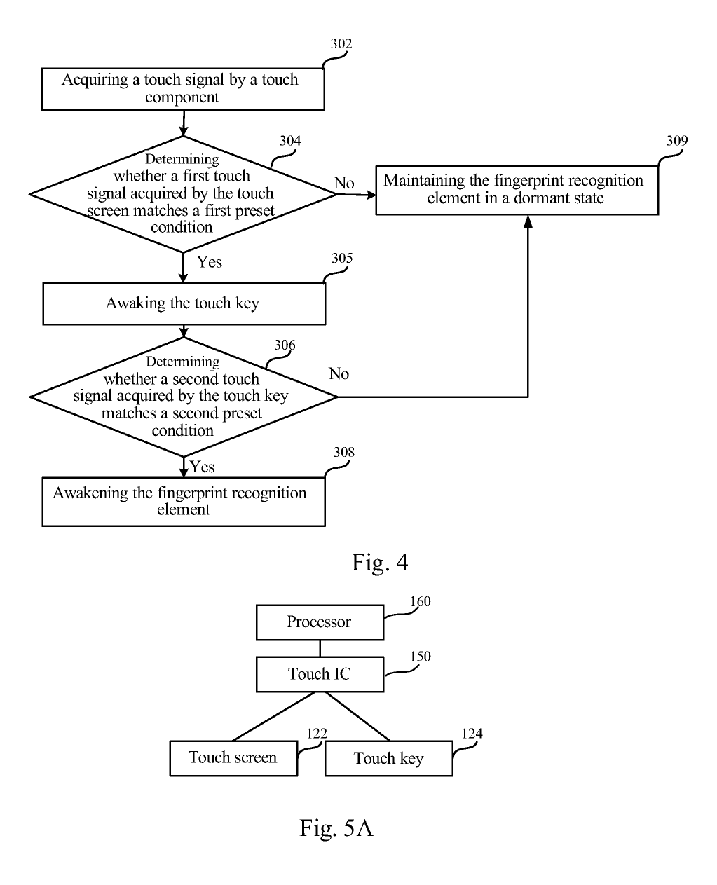

In another embodiment, the following steps may also be included before step 306, as shown in FIG. 4.

In step 305, the touch key is awakened. The touch key is also initially in a dormant state. When the first touch signal acquired by the touch screen matches the first preset condition, the mobile terminal awakes the touch key. The touch key is used to, after being awakened, acquire the second touch signal.

The method for awakening an element provided by the present embodiment makes the touch key be also initially in a dormant state, which may better reduce power consumption and lengthen the runtime of the mobile terminal.

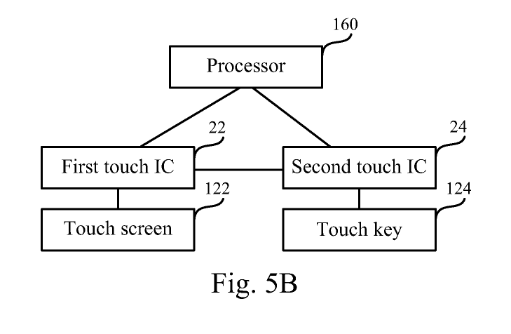

It is to be noted that, the touch screen 122 and the touch key 124 may be controlled by the same touch IC 150, as shown in FIG. 5A. The touch screen 122 and the touch key 124 may also be controlled by different touch ICs, as shown in FIG. 5B. The touch screen 122 is connected with the first touch IC 22, the touch key 124 is connected with the second touch IC 24, and the first touch IC 22 and the second touch IC 24 are connected with the processor 160 respectively.

When the touch screen 122 and the touch key 124 are controlled by the same touch IC, the step 304 may be performed by the processor of the mobile terminal or the touch IC. When the step 304 is performed by the touch IC, if the first touch signal matches the first touch condition, the touch IC directly awakes the touch key 124, which does not need the processor 160 to participate in. The processor 160 may maintain a dormant state in this process to reduce the power consumption as much as possible.

When the touch screen 122 and the touch key 124 are controlled by different touch ICs, the step 304 may be performed by the processor of the mobile terminal or the first touch IC 22. When the step 304 is performed by the first touch IC 22, if the first touch signal matches the first touch condition, the first touch IC 22 communicates with the second touch IC 24 to awaken the touch key 124 by the transfer of the processor 160 or the communication between ICs. When the first touch IC 22 and the second touch IC 24 use the communication between ICs, the process does not need the processor 160 to participate in. The processor 160 may maintain a dormant state in this process to reduce the power consumption as much as possible.

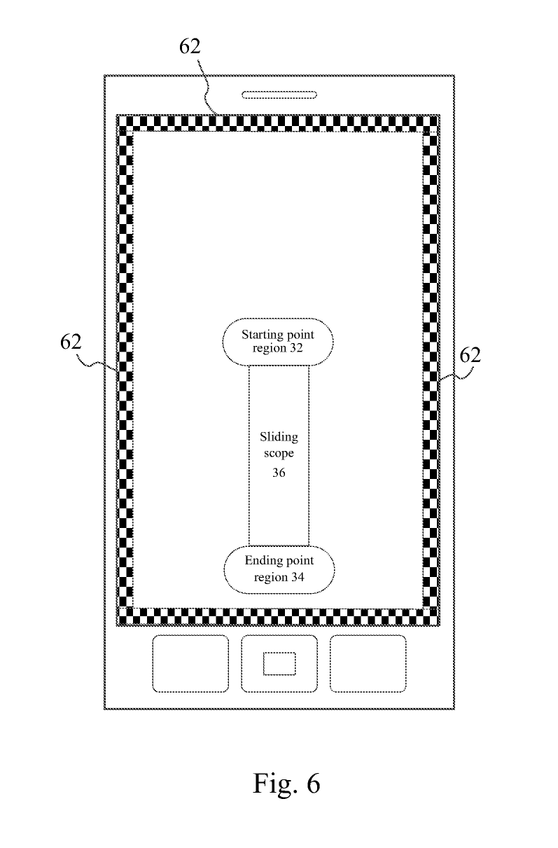

In another embodiment, when the user grabs the mobile terminal, the edge of the finger may possibly falsely contact the edge region of the touch screen 122. The mobile terminal sets an entire or a partial marginal region of the touch screen 122 as a shielding region when the touch screen 122 acquires the first touch signal. As shown in FIG. 6, in the process of the touch screen 122 acquiring the first touch signal, the four edge regions 62 of the touch screen 122 are all set as shielding regions. At this time, even if the finger of the user falsely contacts the edge region 62, it will not affect the mobile terminal to normally determine whether the first touch signal matches the first preset condition.

The size of the edge regions 62 may be set in advance. One implementation of the shielding region is not to collect the touch signal in the shielding region. Another implementation of the shielding region is to collect the touch signal in the shielding region, but ignore the collected touch signal in the shielding region.

The collecting region of the fingerprint recognition element is limited, which is usually smaller than the key area of the touch key. Therefore, when the finger of the user stays on the touch key, the position of the finger may not be completely in the collecting region of the fingerprint recognition element, causing that the fingerprint recognition cannot be finished smoothly. For this purpose, the following embodiments are described.

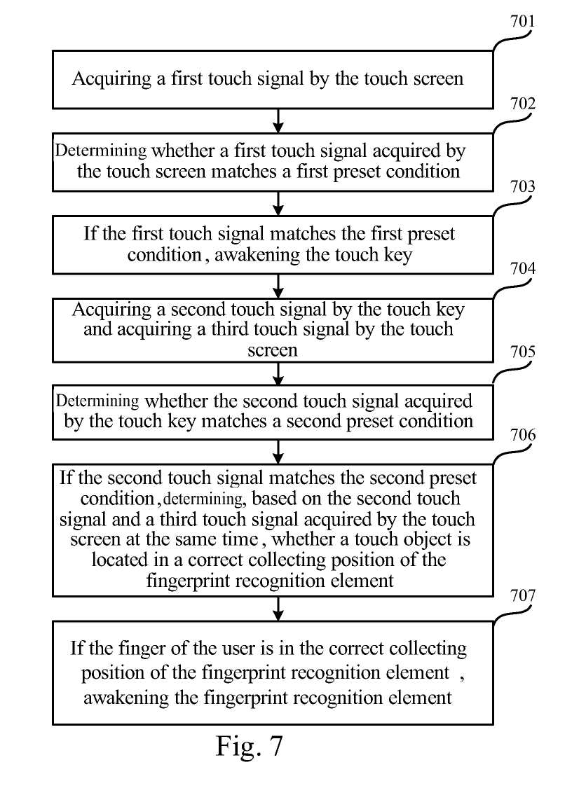

FIG. 7 is a flow chart showing a method for awakening an element according to another exemplary embodiment. The present embodiment is illustrated by taking an example that applies the method for awakening an element to the mobile terminal as shown in FIGS. 1 and 5B. The method includes the following steps.

In step 701, a first touch signal is acquired by the touch screen. The mobile terminal is in a standby state, and the processor and the touch key are both in a dormant state. The touch screen is in a screen-extinguished detecting state with low power consumption.

When the finger of the user touches the touch screen, the mobile terminal acquires the first touch signal by the touch screen. The touch screen may be in a screen-extinguished detecting state with low power consumption.

Combining with shown in FIG. 3B, the finger of the user slides downward from the center of the touch screen 122, and the mobile terminal acquires the first touch signal by the touch screen 122.

In step 702, it is determined whether the first touch signal acquired by the touch screen matches a first preset condition. The first touch IC connected with the touch screen determines whether the first touch signal acquired by the touch screen matches the first preset condition.

The first preset condition includes, but not limited to, a single touch object sliding from a starting point region to an ending point region within the sliding scope.

In step 703, if the first touch signal matches the first preset condition, the touch key is awakened. When the first touch signal matches the first preset condition, the first touch IC sends an awakening signal to the second touch IC through the communication between ICs. The second touch IC awakes the touch key based on the awakening signal. The touch key, after being awakened, acquires the second touch signal.

It is to be noted that, the first touch signal and the second touch signal are usually generated by one sliding operation of the user. The sliding operation is a signal that slides downward from the center of the touch screen 122 to the touch key 124 and stays thereon.

In step 704, a second touch signal is acquired by the touch key and a third touch signal is acquired by the touch screen. When the finger of the user slides to the touch key, the mobile terminal acquires the second touch signal by the touch key.

Because the distance between the touch screen and the touch key is short, the majority of the finger is on the touch key and a small part of the finger is on the touch screen. That is, when the touch key acquires the second touch signal, the touch screen may acquire the third touch signal at the same time. The second touch signal and the third touch signal are touch signals respectively generated when the touch object (for example, the finger) contacts the touch key and the touch screen at the same time.

In step 705, it is determined whether the second touch signal acquired by the touch key matches a second preset condition. The second touch IC connected with the touch key determines whether the second touch signal acquired by the touch key matches the second preset condition. The second preset condition includes, but not limited to, the signal amount generated when the touch object continuously touches on the touch key being larger than a preset threshold. The second preset condition may determine whether the finger of the user stays on the touch key.

In step 706, if the second touch signal matches the second preset condition, it is determined, based on the second touch signal and a third touch signal acquired by the touch screen at the same time, whether a touch object is located in a correct collecting position of the fingerprint recognition element.

When the most part of the finger is on the touch key and a small part of the finger is on the touch screen, the mobile terminal recognizes the position of the finger of the user at a certain degree based on the third touch signal generated on the touch screen by the finger. That is, the mobile terminal determines, based on the second touch signal and a third touch signal acquired by the touch screen at the same time, whether a touch object is located in a correct collecting position of the fingerprint recognition element.

When the second touch signal matches the second preset condition, the second touch IC sends a confirmation signal to the first touch IC. The first touch IC determines whether the third touch signal is within a preset touch scope. If it is within the preset touch scope, the finger of the user is treated as being in the correct collecting position of the fingerprint recognition element. If it goes beyond the preset touch scope, the finger of the user is treated as being not in the correct collecting position of the fingerprint recognition element. The processor may also perform the determination operation of the second touch IC as to the second touch signal and the determination operation of the first touch IC as to the third touch signal.

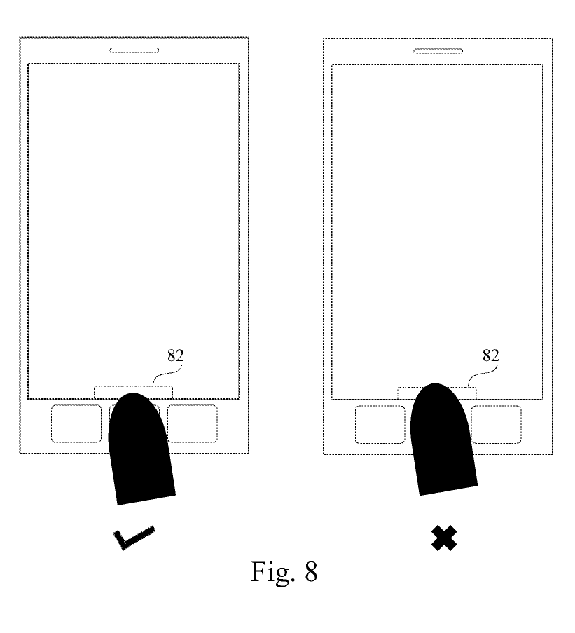

The size and position of the touch scope is determined by the technicians based on a plurality of actual simulations. Combining with shown in FIG. 8, the touch scope is usually the edge region on the touch screen adjacent to the touch key. If the finger of the user is within the touch scope, the finger of the user is treated as being in the correct collecting position of the fingerprint recognition element. If the finger of the user goes beyond the touch scope, the finger of the user is treated as being not in the correct collecting position of the fingerprint recognition element.

In step 707, if the finger of the user is in the correct collecting position of the fingerprint recognition element, the fingerprint recognition element is awakened. When the second touch signal matches the second touch condition and the finger of the user is in the correct collecting position of the fingerprint recognition element, the fingerprint recognition element is awakened. The awakened fingerprint recognition element performs the fingerprint recognition function.

Accordingly, in the method for awakening an element provided by the present embodiment, the determination is performed by combining the second touch signal and the third touch signal, so that the fingerprint recognition element is awakened only when the finger of the user is in the correct collecting position of the fingerprint recognition element, which may reduce the generation of failure events of the fingerprint recognition, and further reduce the power consumption.

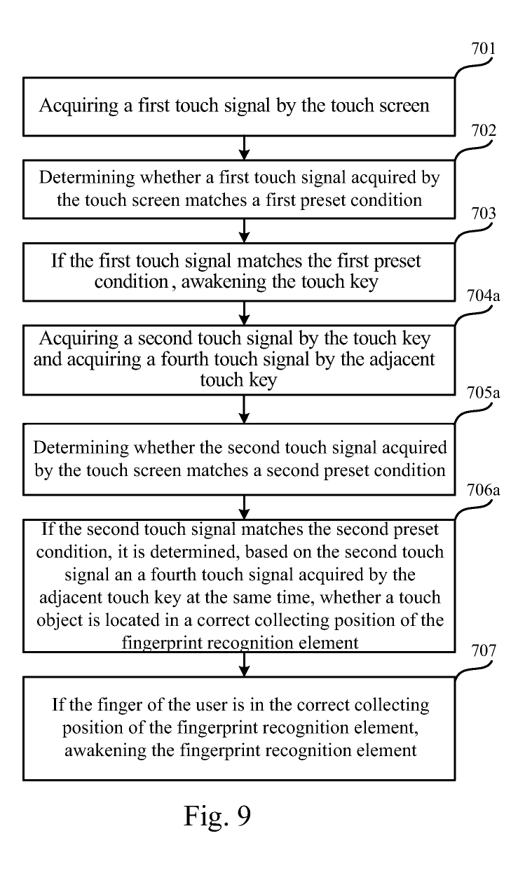

In another implementation, the steps 704-706 may be replaced by steps 704a-706a, as shown in FIG. 9.

In step 704a, the second touch signal is acquired by the touch key, and a fourth touch signal is acquired by the adjacent touch key. When the finger of the user slides to the touch key, the mobile terminal acquires the second touch signal by the touch key.

Because the distance between the touch screen and the touch key is short, the most part of the finger is on the middle touch key, and a small part of the finger is on the adjacent touch screen. That is, when the touch key acquires the second touch signal, the adjacent touch key may acquire the fourth touch signal at the same time. The second touch signal and the fourth touch signal are touch signals respectively generated when the touch object (the finger) contacts the touch key and the touch screen at the same time.

In step 705a, it is determined whether the second touch signal acquired by the touch key matches a second preset condition. The second touch IC connected with the touch key determines whether the second touch signal acquired by the touch key matches the second preset condition. The second preset condition includes, but not limited to, the signal amount generated when the touch object continuously touches on the touch key being larger than a preset threshold. The second preset condition may determine whether the finger of the user stays on the middle touch key.

In step 706a, if the second touch signal matches the second preset condition, it is determined, based on the second touch signal and the fourth touch signal acquired by the adjacent touch key at the same time, whether the touch object is located in a correct collecting position of the fingerprint recognition element.

When the majority of the finger is on the touch key, and a small part of the finger is on the adjacent touch key, the processor of the mobile terminal may recognize the position of the finger of the user to a certain degree based on the fourth touch signal generated on the adjacent touch key by the finger. That is, the processor of the mobile terminal determines, based on the second touch signal and a fourth touch signal acquired by the adjacent touch key at the same time, whether a touch object is located in a correct collecting position of the fingerprint recognition element.

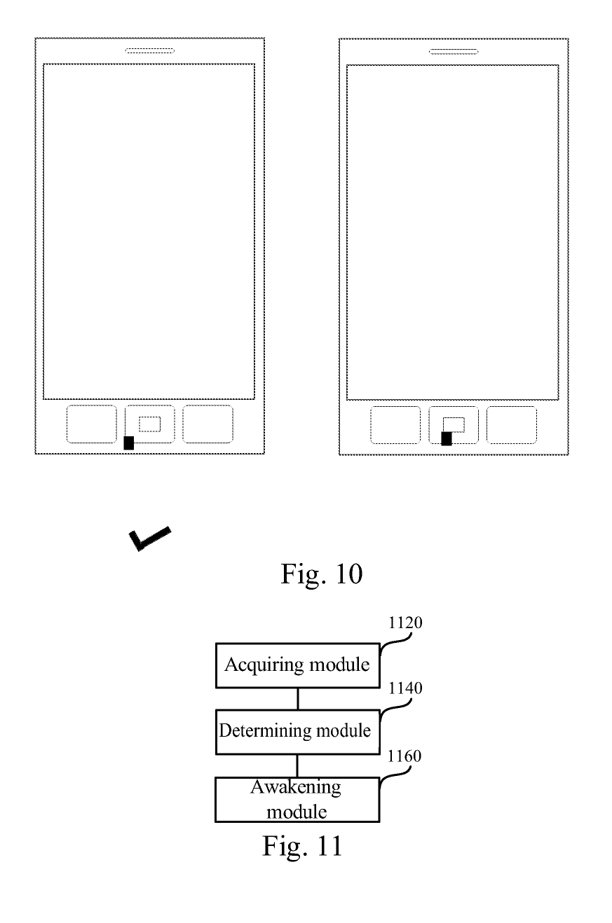

When the second touch signal matches the second preset condition, the second touch IC further determines whether the signal amount of the fourth touch signal is smaller than a preset threshold. If it is smaller than the preset threshold, it is treated as that the part of the finger of the user being on the adjacent touch key is small, and the finger of the user is in the correct collecting position of the fingerprint recognition element. If it goes beyond the preset threshold, it is treated as that the part of the finger of the user being on the adjacent touch key is large, and the finger of the user is not in the correct collecting position of the fingerprint recognition element. The processor may also perform the determination operation of the second touch IC as to the second touch signal and the fourth touch signal. The process may be shown as FIG. 10.

In the following embodiments of devices according to the present disclosure, the devices may be configured to perform the method in the above embodiments of the present disclosure. Details not disclosed in the embodiments of devices may be referred to the embodiments of methods.

FIG. 11 is a block diagram illustrating a device for awakening an element according to an exemplary embodiment. The device for awakening an element may constitute all or a part of the mobile terminal by software, hardware or a combination thereof. The device for awakening an element may include an acquiring module 1120 configured to acquire a touch signal by a touch component, a determining module 1140 configured to determine whether the touch signal matches a preset condition, and an awakening module 1160 configured to, if the touch signal matches the preset condition, awaken a fingerprint recognition element.

Accordingly, in the device for awakening an element provided by the present embodiment, a fingerprint recognition element is awakened when a touch signal acquired by the touch component matches a preset condition, and it solves the problem that the fingerprint recognition element will seriously affect the runtime of the mobile terminal Thereby, it achieves the effect that the fingerprint recognition element is awakened only in partial occasions and it is in a dormant state most of the times, which will not seriously affect the runtime of the mobile terminal.

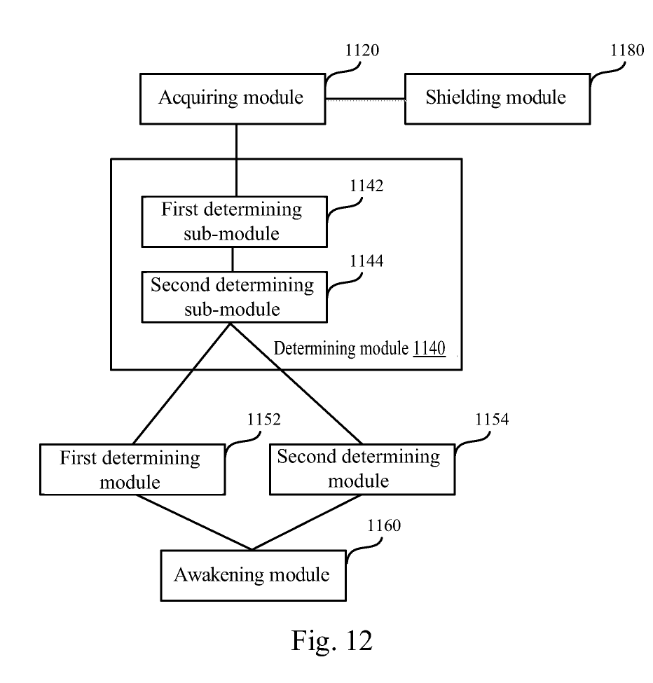

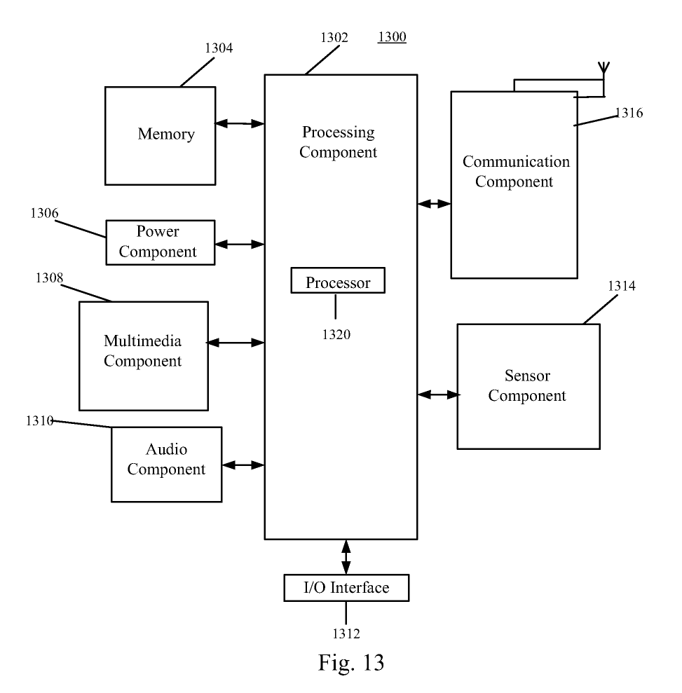

FIG. 12 is a block diagram illustrating a device for awakening an element according to another exemplary embodiment. The device for awakening an element may constitute all or a part of the mobile terminal by software, hardware or a combination thereof. The device for awakening an element may include an acquiring module 1120 configured to acquire a touch signal by a touch component, a determining module 1140 configured to determine whether the touch signal matches a preset condition, and an awakening module 1160 configured to, if the touch signal matches the preset condition, awaken a fingerprint recognition element.

For example, the touch component includes a touch screen and a touch key located at a peripheral side of the touch screen. The determining module 1140 includes a first determining sub-module 1142 configured to determine whether a first touch signal acquired by the touch screen matches a first preset condition, and a second determining sub-module 1144 configured to, if the first touch signal matches the first preset condition, determine whether a second touch signal acquired by the touch key matches a second preset condition.

For example, the device further includes a key awakening sub-module 1143 configured to, if the first touch signal matches the first preset condition, awaken the touch key which, after being awakened, acquires the second touch signal.

For example, the fingerprint recognition element is provided in the touch key. As one possible implementation, the device further includes a first determining module 1152 configured to determine, based on the second touch signal and a third touch signal acquired by the touch screen at the same time, whether a touch object is located in a correct collecting position of the fingerprint recognition element, and the awakening module 1160 configured to awaken the fingerprint recognition element when the touch object is located in the correct collecting position of the fingerprint recognition element. The second touch signal and the third touch signal are touch signals respectively generated when the touch object contacts the touch key and the touch screen at the same time.

In another possible implementation, the device further includes a second determining module 1154 configured to determine, based on the second touch signal and a fourth touch signal acquired by the adjacent touch key at the same time, whether the touch object is located in the correct collecting position of the fingerprint recognition element, and the awakening module 1160 configured to, when the touch object is located in the correct collecting position of the fingerprint recognition, perform steps of the awakening the fingerprint recognition element. The second touch signal and the fourth touch signal are touch signals respectively generated when the touch object contacts the touch key and the adjacent touch key at the same time.

For example, the device further includes a shielding module 1180 configured to set an entire or a partial marginal region of the touch screen as a shielding region when the touch screen acquires the first touch signal.

With respect to the devices in the above embodiments, the specific manners for performing operations for individual modules therein have been described in detail in the embodiments regarding the relevant methods, which will not be elaborated herein.

As shown in FIG. 13 is a device 1300 for awakening an element according to an exemplary embodiment. For example, the device 1300 may be a mobile phone, a computer, a digital broadcast terminal, a messaging device, a gaming console, a tablet, a medical device, exercise equipment, a personal digital assistant, and the like.

Referring to FIG. 13, the device 1300 may include one or more of the following components a processing component 1302, a memory 1304, a power component 1306, a multimedia component 1308, an audio component 1310, an input/output (I/O) interface 1312, a sensor component 1314, and a communication component 1316.

The processing component 1302 typically controls overall operations of the device 1300, such as the operations associated with display, telephone calls, data communications, camera operations, and recording operations. The processing component 1302 may include one or more processors 1320 to execute instructions to perform all or part of the steps in the above described methods. Moreover, the processing component 1302 may include one or more modules which facilitate the interaction between the processing component 1302 and other components. For instance, the processing component 1302 may include a multimedia module to facilitate the interaction between the multimedia component 1308 and the processing component 1302.

The memory 1304 is configured to store various types of data to support the operation of the device 1300. Examples of such data include instructions for any applications or methods operated on the device 1300, contact data, phonebook data, messages, pictures, video, etc. The memory 1304 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1306 provides power to various components of the device 1300. The power component 1306 may include a power management system, one or more power sources, and any other components associated with the generation, management, and distribution of power in the device 1300.

The multimedia component 1308 includes a screen providing an output interface between the device 1300 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1308 includes a front camera and/or a rear camera. The front camera and the rear camera may receive an external multimedia datum while the device 1300 is in an operation mode, such as a photographing mode or a video mode. Each of the front camera and the rear camera may be a fixed optical lens system or have focus and optical zoom capability.

The audio component 1310 is configured to output and/or input audio signals. For example, the audio component 1310 includes a microphone (“MIC”) configured to receive an external audio signal when the device 1300 is in an operation mode, such as a call mode, a recording mode, and a voice recognition mode. The received audio signal may be further stored in the memory 1304 or transmitted via the communication component 1316. In some embodiments, the audio component 1310 further includes a speaker to output audio signals.

The I/O interface 1312 provides an interface between the processing component 1302 and peripheral interface modules, such as a keyboard, a click wheel, keys, and the like. The keys may include, but are not limited to, a home key, a volume key, a starting key, and a locking key. The key may be a touch key, and a fingerprint recognition element may be provided in the touch key.

The sensor component 1314 includes one or more sensors to provide status assessments of various aspects of the device 1300. For instance, the sensor component 1314 may detect an open/closed status of the device 1300, relative positioning of components, e.g., the display and the keypad, of the device 1300, a change in position of the device 1300 or a component of the device 1300, a presence or absence of user contact with the device 1300, an orientation or an acceleration/deceleration of the device 1300, and a change in temperature of the device 1300. The sensor component 1314 may include a proximity sensor configured to detect the presence of nearby objects without any physical contact. The sensor component 1314 may also include a light sensor, such as a CMOS or CCD image sensor, for use in imaging applications. In some embodiments, the sensor component 1314 may also include an accelerometer sensor, a gyroscope sensor, a magnetic sensor, a pressure sensor, or a temperature sensor.

The communication component 1316 is configured to facilitate communication, wired or wirelessly, between the device 1300 and other devices. The device 1300 may access a wireless network based on a communication standard, such as WiFi, 2G, or 3G, or a combination thereof. In one exemplary embodiment, the communication component 1316 receives a broadcast signal or broadcast associated information from an external broadcast management system via a broadcast channel. In one exemplary embodiment, the communication component 1316 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the device 1300 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 1304, executable by the processor 1320 in the device 1300, for performing the above-described methods. For example, the non-transitory computer-readable storage medium may be a ROM, a RAM, a CD-ROM, a magnetic tape, a floppy disc, an optical data storage device, and the like.

A non-transitory computer readable storage medium, when instructions in the storage medium is executed by the processor of the device 1300, enables the device 1300 to perform the method provided by the above-mentioned embodiments.

Each module, such as those discussed with respect to FIGS. 11 and 12, may take the form of a packaged functional hardware unit designed for use with other components, a portion of a program code (e.g., software or firmware) executable by a (micro)processor or processing circuitry that usually performs a particular function of related functions, or a self-contained hardware or software component that interfaces with a larger system, for example.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for awakening a fingerprint recognition element of a device, comprising:
receiving a touch signal by a touch component of the device;
determining whether the touch signal matches a preset condition; and
when the touch signal matches the preset condition, awakening the fingerprint recognition element.

2. The method of claim 1, wherein the touch component comprises a touch screen and a touch key located at a peripheral side of the touch screen, and the determining whether the touch signal matches a preset condition comprises:
determining whether a first touch signal acquired by the touch screen matches a first preset condition; and
when the first touch signal matches the first preset condition, determining whether a second touch signal received by the touch key matches a second preset condition.

3. The method of claim 2, further comprising:
when the first touch signal matches the first preset condition, awakening the touch key which, after being awakened, receives the second touch signal.

4. The method of claim 2, wherein the fingerprint recognition element is located in the touch key, further comprising:
determining, based on the second touch signal and a third touch signal received by the touch screen, whether a touch object is located in a predetermined collecting position of the fingerprint recognition element; and
if the touch object is located in the predetermined collecting position of the fingerprint recognition element, performing the awakening the fingerprint recognition element,
wherein the second touch signal and the third touch signal are respectively generated when the touch object contacts the touch key and the touch screen at the same time.

5. The method of claim 2, wherein an adjacent touch key is provided at a peripheral side of the touch key, and the method further comprises:
determining, based on the second touch signal and a fourth touch signal acquired by the adjacent touch key at the same time, whether the touch object is located in the predetermined collecting position of the fingerprint recognition element; and
if the touch object is located in the predetermined collecting position of the fingerprint recognition element, performing the awakening the fingerprint recognition element,
wherein the second touch signal and the fourth touch signal are respectively generated when the touch object contacts the touch key and the adjacent touch key at the same time.

6. The method of claim 2, further comprising:
setting an entire or a partial marginal region of the touch screen as a shielding region when the touch screen acquires the first touch signal.

7. The method of claim 2, wherein determining whether a second touch signal acquired by the touch key matches a second preset condition comprises determining whether a signal amount for the second touch signal is larger than a preset threshold.

8. The method of claim 2, wherein the first preset condition comprises a single touch object sliding on the touch screen.

9. The method of claim 5, wherein determining whether the touch object is located in the predetermined collecting position of the fingerprint recognition element comprises determining whether a signal amount of the fourth touch signal is smaller than a preset threshold.

10. A device comprising:
a processor;
a memory for storing instructions executable by the processor;
a touch sensor; and
a fingerprint recognition element;
wherein the processor is configured to:
receive a touch signal by the touch sensor;
determine whether the touch signal matches a preset condition; and
when the touch signal matches the preset condition, awaken the fingerprint recognition element.

11. The device of claim 10, wherein the touch sensor comprises a touch screen and a touch key located at a peripheral side of the touch screen, and the processor is further configured to:
determine whether a first touch signal acquired by the touch screen matches a first preset condition; and
when the first touch signal matches the first preset condition, determine whether a second touch signal acquired by the touch key matches a second preset condition.

12. The device of claim 11, wherein the processor is further configured to:
when the first touch signal matches the first preset condition, awaken the touch key which, after being awakened, acquires the second touch signal.

13. The device of claim 11, wherein the fingerprint recognition element is positioned in the touch key, and the processor is further configured to:
determine, based on the second touch signal and a third touch signal acquired by the touch screen at the same time, whether a touch object is located in a predetermined collecting position of the fingerprint recognition element; and
awaken the fingerprint recognition element when the touch object is located in the predetermined collecting position of the fingerprint recognition element,
wherein the second touch signal and the third touch signal are respectively generated when the touch object contacts the touch key and the touch screen at the same time.

14. The device of claim 11, wherein an adjacent touch key is provided at a peripheral side of the touch key, and the processor is further configured to:
determine, based on the second touch signal and a fourth touch signal acquired by the adjacent touch key at the same time, whether the touch object is located in a predetermined collecting position of the fingerprint recognition element; and
when the touch object is located in the predetermined collecting position of the fingerprint recognition, perform the awakening the fingerprint recognition element,
wherein the second touch signal and the fourth touch signal are respectively generated when the touch object contacts the touch key and the adjacent touch key at the same time.

15. The device of claim 10, wherein the processor is further configured to:
set an entire or a partial marginal region of the touch screen as a shielding region when the touch screen acquires the first touch signal.

16. The device of claim 11, wherein the processor is further configured to:
set an entire or a partial marginal region of the touch screen as a shielding region when the touch screen acquires the first touch signal.

17. The device of claim 12, wherein the processor is further configured to:
set an entire or a partial marginal region of the touch screen as a shielding region when the touch screen acquires the first touch signal.

18. The device of claim 13, wherein the processor is further configured to:
set an entire or a partial marginal region of the touch screen as a shielding region when the touch screen acquires the first touch signal.

19. The device of claim 14, wherein the processor is further configured to:
set an entire or a partial marginal region of the touch screen as a shielding region when the touch screen acquires the first touch signal.

20. A non-transitory storage medium having stored therein instructions that, when executed by one or more processors of a terminal for awakening a fingerprint recognition element, causes the terminal to perform:
acquiring a touch signal by a touch component of the terminal;
determining whether the touch signal matches a preset condition; and
if the touch signal matches the preset condition, awakening the fingerprint recognition element.
